(19) United States
(12) Patent Application Publication
(10) Pub. No.: US 2017/0180468 A1
(43) Pub. Date: Jun. 22, 2017

(54) Method, electronic device and non-transitory computer-readable storage medium for connecting P2P network node

(71) Applicants: Le Holdings (Beijing) Co., Ltd., Beijing (CN); LeCloud Computing Co., Ltd., Beijing (CN)

(72) Inventor: Zhuo Li, Beijing (CN)

(21) Appl. No.: 15/246,569

(22) Filed: Aug. 25, 2016

Related U.S. Application Data
(63) Continuation of application No. PCT/CN2016/089463, filed on Jul. 8, 2016.

(30) Foreign Application Priority Data
Dec. 21, 2015 (CN) 201510967776.5

(51) Int. Cl. H04L 29/08; H04L 12/26

(52) U.S. Cl. CPC H04L 67/104; H04L 43/10; H04L 67/34

(57) ABSTRACT

Disclosed are a method, an electronic device and a non-transitory computer-readable storage medium for connecting a P2P network node. The present disclosure adopts a technical solution as below: determining whether data downloaded by a first node has been finished downloading; acquiring a download status of a second node in downloading data if the data downloaded by the first node has been finished downloading; disconnecting the second node from the first node if the download status of the second node in downloading data is downloading finished; sending a connection status of a connection between the first node and other nodes in the P2P network to a server so that the server allocates nodes in the P2P network to establish a connection with the first node according to a connection status of the first node; and receiving a third node allocated by the server and establishing a connection between the first node and the third node.

### CROSS REFERENCE TO RELATED APPLICATIONS

This application is a continuation of International Application No. PCT/CN2016/089463, filed on Jul. 8, 2016, which is based upon and claims priority to Chinese Patent Application No. 201510967776.5, filed on Dec. 21, 2015, the entire contents of all of which are incorporated herein by reference.

### TECHNICAL FIELD

The present disclosure relates to communications technologies, and more particularly, to a method, an electronic device and a non-transitory computer-readable storage medium for connecting a P2P network node.

### BACKGROUND

In a client/server (C/S) system, a specialized server is employed to distribute data, and a plurality of clients acquire data from the server. However, in this mode, the number of servers is limited or only one, which may easily cause that a single server faces to a plurality of clients. Furthermore, a central processing unit (CPU) of the server is limited in capacity, memory capacity and network bandwidth, and meantime serviceable clients are limited in quantity and poor in extendibility.

An existing Peer to Peer (P2P) technology can solve the problems of the C/S system. The P2P technology is also referred to as Internet peer-to-peer technology, which is a network information interaction manner relative to the C/S system mode. In a P2P network, each node not only may obtain services from other nodes, but also may provide services for other nodes. In this way, the problem of poor extendibility of a single server in the C/S system is solved.

During downloading interaction data between P2P network nodes, a connection relationship between a node A and a node B is maintained. However, the connection relationship between the node A and the node B is still maintained when the node A and the node B finish data downloading. Due to limitation of the CPU capacity, the memory capacity and the network bandwidth of a node, any node in a network has an upper limit of connection nodes, which causes that the node A or the node B may mutually occupy a connection quota of the other party although the node A and the node B finish data downloading, and thus they are unable to transmit data to other nodes having not finished data downloading, thereby having a negative effect on an efficiency in sharing a P2P network node.

### SUMMARY

The present disclosure provides a method, an electronic device and a non-transitory computer-readable storage medium for connecting a P2P network node to improve efficiency in sharing a P2P network node.

In a first aspect, embodiments of the present disclosure provide a method for connecting a P2P network node, implemented by a terminal, including:

determining whether data downloaded by a first node has been finished downloading, the first node being any node in a P2P network;

acquiring a download status of a second node in downloading data if the data downloaded by the first node has been finished downloading, wherein the second node is any node in the P2P network connected with the first node; and

disconnecting the second node from the first node and informing a server to update connection status information if the download status of the second node in downloading data is downloading finished.

In a second aspect, embodiments of the present disclosure provide a non-transitory computer-readable storage medium storing executable instructions, wherein the executable instructions are configured to perform any methods for connecting a P2P network node mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for connecting a P2P network node mentioned by embodiments of the present disclosure.

According to a method, an electronic device and a non-transitory computer-readable storage medium for connecting a P2P network node provided by embodiments of the present disclosure, a download status of a second node in downloading data is acquired after determining whether data downloaded by a first node has been finished downloading; and the second node is disconnected from the first node if the download status of the second node in downloading data is downloading finished. In this way, a case where a connection between the two nodes is still maintained although data downloading has been finished is avoided, and a waste of resources is reduced. A connection status of a connection between the first node and other nodes in the P2P network is sent to a server so that the server allocates nodes in the P2P network to establish a connection with the first node according to a connection status of the first node, thereby effectively utilizing node resources and improving an efficiency in sharing a P2P network node.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for connecting a P2P network node in accordance with some embodiments;

FIG. 2 is a flowchart of another method for determining whether data downloaded by a first node has been finished downloading in accordance with some embodiments;

FIG. 3 is a composition block diagram of an apparatus for connecting a P2P network node in accordance with some embodiments;

FIG. 4 is a composition block diagram of another apparatus for connecting a P2P network node in accordance with some embodiments;

FIG. 5 is a composition block diagram of still another apparatus for connecting a P2P network node in accordance with some embodiments;

FIG. 6 is a block diagram of a system for connecting a P2P network node in accordance with some embodiments;

FIG. 7 is a schematic structural diagram of an apparatus for connecting a P2P network node in accordance with some embodiments; and

FIG. 8 is a block diagram of an electronic device which is configured to perform the methods for connecting a P2P network node in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

Embodiments of the present disclosure provide a method for connecting a P2P network node, as shown in FIG. 1, the method includes following steps.

101: It is determined whether data downloaded by a first node has been finished downloading.

The first node is any node in a P2P network, which can be a client and specifically a computer or other device terminals. The node is not limited in the present disclosure and can be selected according to the actual situation.

The foregoing P2P network is a peer-to-peer network, which includes a plurality of work nodes, each of which has an identical function and has no master-slave distinction, and these nodes achieve sharing node resources and services through mutual interchange.

102: A download status of a second node in downloading data is acquired if the data downloaded by the first node has been finished downloading.

The second node is any node connected with the first node, and the second node downloads, from the first node, the data having been downloaded by the first node.

Specifically, when acquiring the download status of the second node in downloading data, embodiments of the present disclosure may adopt, but not limited to, a method as below: the first node receives a heartbeat message sent by the second node, where the heartbeat message carries the download status of the second node in downloading data, the heartbeat message can be a heartbeat packet mutually transmitted between the nodes, the heartbeat packet is a self-defined command word mutually transmitted between the nodes for informing the other node of a status of one node and is sent according to a certain time interval; and the first node can acquire the download status of the second node in downloading data according to the heartbeat message, for example, when the second node downloads, from the first node, video data having been downloaded by the first node, the video data can be divided into a plurality of data blocks in a storage procedure, and then the second node may send one heartbeat message to the first node at regular time, where the heartbeat message includes the download status in downloading data such as how many data blocks having been downloaded by the second node at the moment and how many data blocks still needing to be downloaded.

103: The second node is disconnected from the first node and a server is informed to update connection status information if the download status of the second node in downloading data is downloading finished.

If the data downloading status of the second node acquired in Step 102 is downloading finished, this indicates that data downloading between the first node and the second node has been finished, and the second node is disconnected from the first node if there is no mutual data transmission between the two nodes. It is to be noted that the disconnection herein can be unilateral disconnection. And the first node can be automatically disconnected from the second node when the first node determines that the second node has finished downloading according to the download status of the second node.

According to a method for connecting a P2P network node provided by embodiments of the present disclosure, a download status of a second node in downloading data is acquired after determining whether data downloaded by a first node has been finished downloading; and the second node is disconnected from the first node if the download status of the second node in downloading data is downloading finished. In this way, a case where a connection between the two nodes is still maintained although data downloading has been finished is avoided, and a waste of resources is reduced.

In another embodiment of the present disclosure, the method may further include following steps.

104: A connection status of a connection between the first node and other nodes in the P2P network is sent to a server so that the server allocates nodes in the P2P network to establish a connection with the first node according to a connection status of the first node.

The connection status of the first node is a connection status of a connection between the first node and other nodes in the P2P network. The quantity of nodes connected with the first node can be counted out according to the connection status of the first node. Since in Step 103 the first node is disconnected from the second node, at the moment the connection status of the first node may be updated, the quantity of connections counted out indicates that the first node has spare nodes, and the connection status of the current first node is sent to a server so that the server allocates nodes in the P2P network to establish a connection with the first node according to the connection status of the first node.

The foregoing server is a server, in a P2P network, in charge of management of P2P network nodes. The management may include coordinating a connection relationship among nodes. A connection of each node is allocated according to a connection status of the node fed back to the server by the node.

105: A third node allocated by the server is received and a connection between the first node and the third node is established.

It is to be noted that the third node is a node not finishing data downloading. The server allocates the third node to establish a connection with the first node according to a data download status fed back by the third node so as to implement data downloading, thereby effectively utilizing node resources and avoiding a waste of network resources.

In the embodiments of the present disclosure, a connection status of a connection between the first node and other nodes in the P2P network is sent to a server so that the server allocates nodes in the P2P network to establish a connection with the first node according to the connection status of the first node, thereby effectively utilizing node resources and improving an efficiency in sharing a P2P network node.

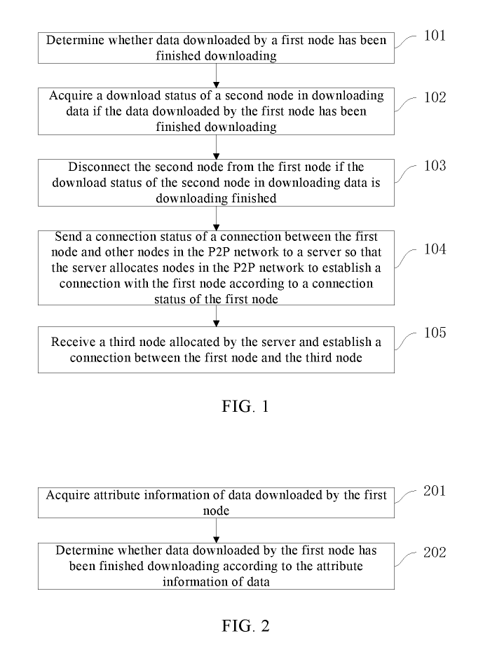

Further, in the embodiments of the present disclosure, when determining whether data downloaded by the first node is finished downloading, it may be implemented by adopting, but not limited to a method as below, as shown in FIG. 2, the method includes following steps.

201: Attribute information of data downloaded by the first node is acquired.

The attribute information of data downloaded by the first node is acquired according to a source from which the first node downloads data. The source may be local data or data in other nodes. The attribute information of data mainly includes: a data size, a data time length and a data type, where the data size mainly refers to number of bytes included in a file; the data time length mainly refers to total time duration of video data, the video data can be stored in block, at the moment the data time length can be a plurality of data blocks of the video data; and the data type mainly refers to a format of the data, which may be audio data or video data and so on, the attribute information of data is not limited in the embodiments of the present disclosure.

202: It is determined whether data downloaded by the first node has been finished downloading according to the attribute information of data.

Further, the first node determines whether data downloaded by the first node is finished downloading according to a download progress of the first node in combination with attribute information of the data file. For example, when the first node demands video data, the first node may acquire the video data from a source from which the data are downloaded according to attribute information of the video data on-demand, for example, how many data blocks included in the downloaded video data, a size and a type of the video data or the like, then the first node determines how many data blocks having been downloaded and how many data blocks still needing to be downloaded according to the download progress of the first node. It is determined the data downloaded by the first node have been finished downloading when it is acquired that the first node has finished downloading all data blocks of the video data.

In the embodiments of the present disclosure, a download status of a second node in downloading data is acquired after determining whether data downloaded by a first node has been finished downloading; and the second node is disconnected from the first node if the download status of the second node in downloading data is downloading finished. In this way, a case where a connection between the two nodes is still maintained although data downloading has been finished is avoided, and a waste of resources is reduced.

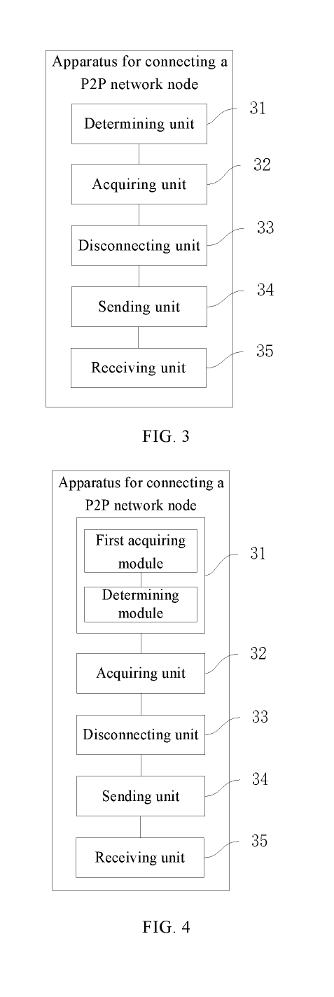

Based on the foregoing method embodiment, embodiments of the present disclosure further provide an apparatus for connecting a P2P network node, the apparatus embodiment corresponds to the preceding method embodiment and can implement all contents in the preceding method embodiment. For ease of reading, the apparatus embodiment merely makes a summary description of contents in the preceding method embodiment instead of detailed description of the contents in the method embodiment. As shown in FIG. 3, the apparatus includes: a determining unit 31, an acquiring unit 32, a disconnecting unit 33, a sending unit 34 and a receiving unit 35.

The determining unit 31 is configured to determine whether data downloaded by a first node has been finished downloading, where the first node is any node in a P2P network.

The acquiring unit 32 is configured to acquire a download status of a second node in downloading data if the data downloaded by the first node has been finished downloading, where the second node is any node in the P2P network connected with the first node.

The disconnecting unit 33 is configured to disconnect the second node from the first node and inform a server to update connection status information if the download status of the second node in downloading data is downloading finished.

According to an apparatus for connecting a P2P network node provided by embodiments of the present disclosure, a download status of a second node in downloading data is acquired after determining whether data downloaded by a first node has been finished downloading; and the second node is disconnected from the first node if the download status of the second node in downloading data is downloading finished. In this way, a case where a connection between the two nodes is still maintained although data downloading has been finished is avoided, and a waste of resources is reduced.

In another embodiment of the present disclosure, the apparatus further includes:

the sending unit 34, configured to send a connection status of a connection between the first node and other nodes in the P2P network to a server so that the server allocates nodes in the P2P network to establish a connection with the first node according to a connection status of the first node; and

the receiving unit 35, configured to receive a third node allocated by the server and establish a connection between the first node and the third node.

In the embodiments of the present disclosure, a connection status of a connection between the first node and other nodes in the P2P network is sent to a server so that the server allocates nodes in the P2P network to establish a connection with the first node according to a connection status of the first node, thereby effectively utilizing node resources and improving an efficiency in sharing a P2P network node.

Further, as shown in FIG. 4, the determining unit 31 includes:

a first acquiring module, configured to acquire attribute information of data downloaded by the first node; and

a determining module, configured to determine whether data downloaded by the first node has been finished downloading according to the attribute information of data, where the attribute information of data includes: a data size, a data time length and a data type.

Further, as shown in FIG. 5, the acquiring unit 32 includes:

a receiving module, configured to receive, by the first node, a heartbeat message sent by the second node, the heartbeat message carrying the download status of the second node in downloading data; and

a second acquiring module, configured to acquire the download status of the second node in downloading data according to the heartbeat message.

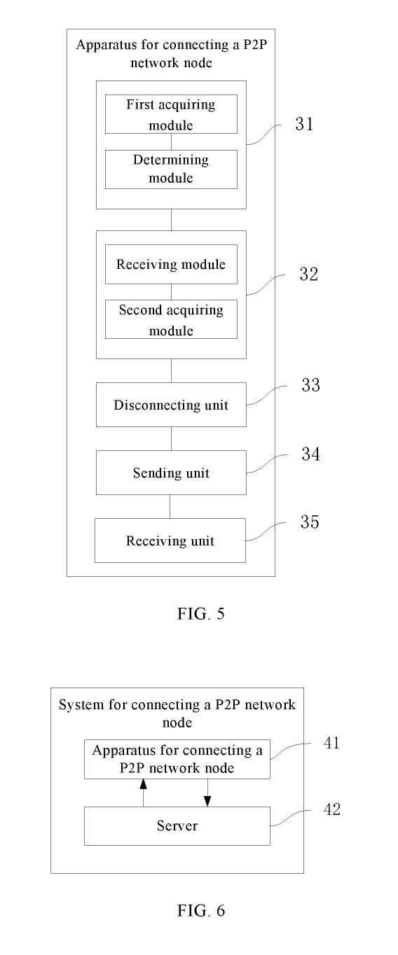

Further, an embodiment of the present disclosure provides a system for connecting a P2P network node, the system embodiment corresponds to the preceding method embodiment and can implement all contents in the preceding method embodiment. For ease of reading, this system embodiment merely makes a summary description of contents in the preceding method embodiment instead of detailed description of the contents in the method embodiment. As shown in FIG. 6, the system includes: an apparatus for connecting a P2P network node 41 and a server 42.

The apparatus for connecting a P2P network node 41 is configured to send a connection status of a connection between the first node and other nodes in the P2P network to a server so that the server allocates other nodes to establish a connection with the first node according to a connection status of the first node.

The server 42 is configured to allocate nodes in the P2P network to establish a connection with the first node according to a connection status of the first node.

The apparatus for connecting a P2P network node 41 is further configured to receive a third node allocated by the server and establish a connection between the first node and the third node.

In conclusion, according to a method, an apparatus and a system for connecting a P2P network node provided by embodiments of the present disclosure, a download status of a second node in downloading data is acquired after determining whether data downloaded by a first node has been finished downloading; and the second node is disconnected from the first node if the download status of the second node in downloading data is downloading finished. In this way, a case where a connection between the two nodes is still maintained although data downloading has been finished is avoided, and a waste of resources is reduced. A connection status of a connection between the first node and other nodes in the P2P network is sent to a server so that the server allocates nodes in the P2P network to establish a connection with the first node according to a connection status of the first node, thereby effectively utilizing node resources and improving an efficiency in sharing a P2P network node.

The apparatus embodiments set forth above are merely exemplary, where units described as detached parts can be or not be detachable physically; parts displayed as units can be or not be physical units, i.e., either located at the same place, or distributed on a plurality of network units. Modules may be selected in part or in whole according to actual needs to achieve objectives of the solution of this embodiment. Those of ordinary skill in the art may comprehend and implement the embodiment without contributing creative effort.

It is to be noted that in allusion to the foregoing apparatus for connecting a P2P network node, functions of each unit module used in the embodiments of the present disclosure can be implemented through a hardware processor.

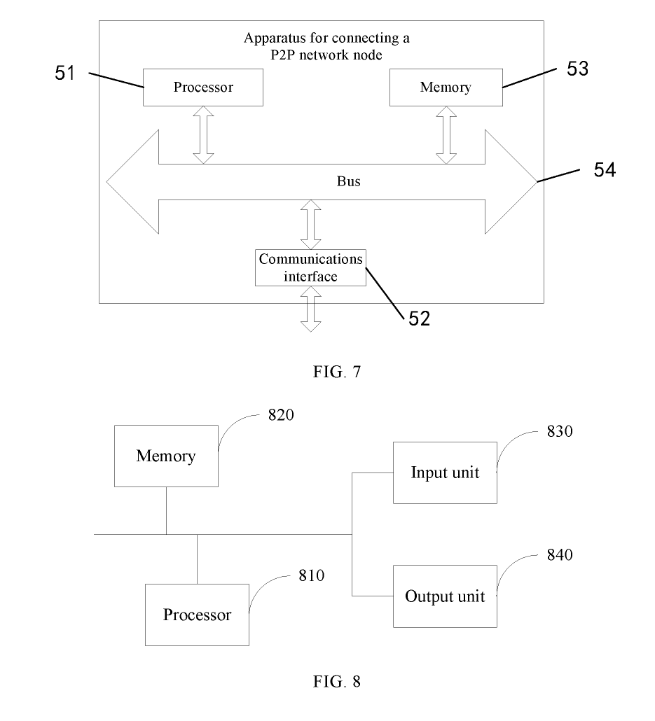

Exemplarily, as shown in FIG. 7, which illustrates a schematic structural diagram of an apparatus for connecting a P2P network node according to embodiments of the present disclosure, the apparatus can include: a processor 51, a communications interface 52, a memory 53 and a bus 54, where the processor 51, the communications interface 52 and the memory 53 complete communications among each other through the bus 54. The communications interface 52 can be configured to implement information transmission between the server and a client. The processor 51 can invoke a logic instruction in the memory 53 to execute a method as below: it is determined whether data of a first node has been finished downloading; a data downloading status of a second node is acquired if the data of the first node has been finished downloading; the second node is disconnected from the first node if the data downloading status of the second node is downloading finished; a connection status of the first node is sent to a server so that the server allocates other nodes to establish a connection with the first node according to the connection status of the first node; and a third node allocated by the server is received and a connection between the first node and the third node is established.

In addition, when a logic instruction in the foregoing memory 53 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for connecting a P2P network node mentioned by embodiments of the present disclosure.

FIG. 8 is a block diagram of an electronic device which is configured to perform the methods for connecting a P2P network node according to an embodiment of the present disclosure. As shown in FIG. 8, the device includes:

one or more processors 810 and memory 820. A processor 810 is showed in FIG. 8 for an example.

Device which is configured to perform the methods for connecting a P2P network node can also include: input unit 830 and output unit 840.

Processor 810, memory 820, input unit 830 and output unit 840 can be connected by BUS or other methods, and BUS connecting is showed in FIG. 8 for an example.

Memory 820 can be used for storing non-transitory software program, non-transitory computer executable program and modules as a non-transitory computer-readable storage medium, such as corresponding program instructions/modules for the methods for connecting a P2P network node mentioned by embodiments of the present disclosure (such as shown in FIG. 3, determining unit 31, acquiring unit 32 and disconnecting unit 33). Processor 810 performs kinds of functions and connecting a P2P network node of the electronic device by executing non-transitory software program, instructions and modules which are stored in memory 820, thereby realizes the methods for connecting a P2P network node mentioned by embodiments of the present disclosure.

Memory 820 can include program storage area and data storage area, thereby the operating system and applications required by at least one function can be stored in program storage area and data created by using the device for connecting a P2P network node can be stored in data storage area. Furthermore, memory 820 can include high speed Random-access memory (RAM) or non-volatile memory such as magnetic disk storage device, flash memory device or other non-volatile solid state storage devices. In some embodiments, memory 820 can include long-distance setup memories relative to processor 810, which can communicate with the device for connecting a P2P network node by networks. The examples of said networks are including but not limited to Internet, Intranet, LAN, mobile Internet and their combinations.

Input unit 830 can be used to receive inputted number, character information and key signals causing user configures and function controls of the device for connecting a P2P network node. Output unit 840 can include a display screen or a display device.

The said module or modules are stored in memory 820 and perform the methods for connecting a P2P network node when executed by one or more processors 810.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for connecting a P2P network node, implemented by a terminal, comprising:
determining whether data downloaded by a first node has been finished downloading, the first node being any node in a P2P network;
acquiring a download status of a second node in downloading data if the data downloaded by the first node has been finished downloading, wherein the second node is any node in the P2P network connected with the first node; and
disconnecting the second node from the first node and informing a server to update connection status information if the download status of the second node in downloading data is downloading finished.

2. The method according to claim 1, further comprising:
sending a connection status of a connection between the first node and other nodes in the P2P network to a server so that the server allocates nodes in the P2P network to establish a connection with the first node according to a connection status of the first node; and
receiving a third node allocated by the server and establishing a connection between the first node and the third node.

3. The method according to claim 1, wherein the determining whether data downloaded by a first node has been finished downloading comprises:
acquiring attribute information of data downloaded by the first node; and
determining whether data downloaded by the first node has been finished downloading according to the attribute information of data.

4. The method according to claim 3, wherein the attribute information of data comprises: a data size, a data time length and a data type.

5. The method according to claim 1, wherein the acquiring a download status of a second node in downloading data comprises:
receiving, by the first node, a heartbeat message sent by the second node, the heartbeat message carrying the download status of the second node in downloading data; and
acquiring the download status of the second node in downloading data according to the heartbeat message.

6. A non-transitory computer-readable storage medium storing executable instructions, wherein the executable instructions are configured to:
determine whether data downloaded by a first node has been finished downloading, the first node being any node in a P2P network;
acquire a download status of a second node in downloading data if the data downloaded by the first node has been finished downloading, wherein the second node is any node in the P2P network connected with the first node; and
disconnect the second node from the first node and inform a server to update connection status information if the download status of the second node in downloading data is downloading finished.

7. The non-transitory computer-readable storage medium according to claim 6, wherein the executable instructions are further configured to:
send a connection status of a connection between the first node and other nodes in the P2P network to a server so that the server allocates nodes in the P2P network to establish a connection with the first node according to a connection status of the first node; and
receive a third node allocated by the server and establish a connection between the first node and the third node.

8. The non-transitory computer-readable storage medium according to claim 6, wherein the determining whether data downloaded by a first node has been finished downloading comprises:
acquiring attribute information of data downloaded by the first node; and
determining whether data downloaded by the first node has been finished downloading according to the attribute information of data.

9. The non-transitory computer-readable storage medium according to claim 8, wherein the attribute information of data comprises: a data size, a data time length and a data type.

10. The non-transitory computer-readable storage medium according to claim 6, wherein the acquiring a download status of a second node in downloading data comprises:
receiving, by the first node, a heartbeat message sent by the second node, the heartbeat message carrying the download status of the second node in downloading data; and
acquiring the download status of the second node in downloading data according to the heartbeat message.

11. An electronic device, comprising:
at least one processor; and
a memory communicably connected with the at least one processor for storing instructions executable by the at least one processor, wherein execution of the instructions by the at least one processor causes the at least one processor to:
determine whether data downloaded by a first node has been finished downloading, the first node being any node in a P2P network;
acquire a download status of a second node in downloading data if the data downloaded by the first node has been finished downloading, wherein the second node is any node in the P2P network connected with the first node; and
disconnect the second node from the first node and inform a server to update connection status information if the download status of the second node in downloading data is downloading finished.

12. The electronic device according to claim 11, wherein the instructions are executed to cause the at least one processor to:
send a connection status of a connection between the first node and other nodes in the P2P network to a server so that the server allocates nodes in the P2P network to establish a connection with the first node according to a connection status of the first node; and
receive a third node allocated by the server and establish a connection between the first node and the third node.

13. The electronic device according to claim 11, wherein the determining whether data downloaded by a first node has been finished downloading comprises:
acquiring attribute information of data downloaded by the first node; and
determining whether data downloaded by the first node has been finished downloading according to the attribute information of data.

14. The electronic device according to claim 13, wherein the attribute information of data comprises:
a data size, a data time length and a data type.

15. The electronic device according to claim 11, wherein the acquiring a download status of a second node in downloading data comprises:
receiving, by the first node, a heartbeat message sent by the second node, the heartbeat message carrying the download status of the second node in downloading data; and
acquiring the download status of the second node in downloading data according to the heartbeat message.
